(19) United States
(12) Patent Application Publication
(10) Pub. No.: US 2008/0243667 A1
(43) Pub. Date: Oct. 2, 2008

(54) Instruments and market for hedging risks in commercial real estate assets

(76) Inventor: Patrick P. Lecomte, Nevers (FR)

Correspondence Address: Mr. Patrick P. Lecomte, 22 rue Paul Vaillant Couturier, Nevers, 58000, FR

(21) Appl. No.: 11/505,974

(22) Filed: Aug. 18, 2006

Related U.S. Application Data
(60) Provisional application No. 60/781,497, filed on Mar. 13, 2006.

(51) Int. Cl. G06Q 40/00

(52) U.S. Cl. 705/37; 705/35

(57) ABSTRACT

Real estate is known for its overwhelmingly idiosyncratic risk structure stemming from heterogeneous real assets traded on imperfect markets with asymmetric information, high transaction costs, low liquidity. In theory, property derivatives should be based on multifactor models cognisant of real estate's fundamental risk structure. In practice, no existing derivatives template can accommodate multi-factors. As a result, property derivatives usually offer poor hedging effectiveness, especially in the context of individual buildings and small, under-diversified portfolios of assets. The specification presents the design of two derivative instruments and market template that accommodate complex risk structures. These instruments and market enable investors to efficiently hedge risks involved in heterogeneous real assets such as commercial real estate assets.

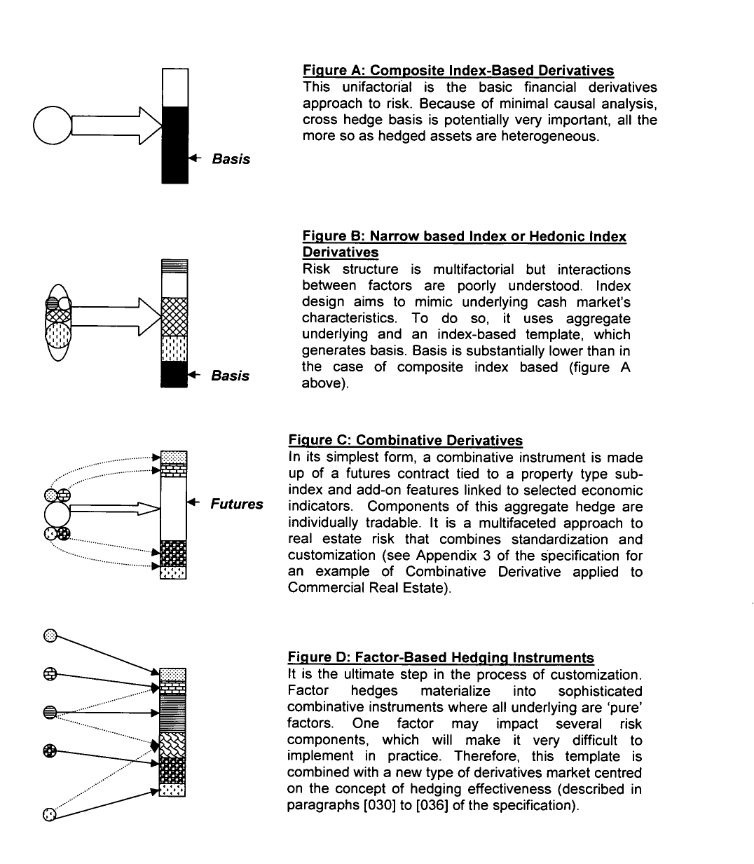

### CROSS REFERENCE TO RELATED APPLICATION

This nonprovisional application for patent is claiming the benefit of the provisional application No. 60/781,497 filed on Mar. 13, 2006.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

The specification contains four appendices attached with this document (pages 16 to 19). Each appendix is one page long.

### BACKGROUND OF THE INVENTION

Real estate is known for its overwhelmingly idiosyncratic risk structure stemming from heterogeneous real assets traded on imperfect markets with asymmetric information, high transaction costs, low liquidity (see Miles and McCue [1982]). Encapsulating these characteristics within a single hedging instrument or series of instruments is a major hurdle that academics and industry participants have so far found impossible to overcome. Indeed, although index-based derivatives aimed at investors in private commercial real estate assets have been recently introduced in the US and Europe (see Fisher [2005]), they do not satisfactorily address real estate investors' hedging needs. In theory, property derivatives should be based on multifactor models cognisant of real estate's fundamental risk structure. In practice, no existing derivatives template knows how to accommodate multi-factors. Existing property derivatives suppose that real estate risk be explained by a market model such as the Capital Asset Pricing Model where only market risk ultimately matters for investors (see Lecomte and McIntosh [2006]). In essence, current property derivatives are meant for hedging at the aggregate level whereas heterogeneous real assets such as commercial real estate assets require a more nuclear approach. As a result, property derivatives usually offer poor hedging effectiveness, especially in the context of individual buildings and small, under-diversified portfolios of assets. The term hedging effectiveness is derived from the hedging theory (see Fishburn [1977], Ederington [1979], Howard and D'Antonio [1984]). It refers to the basic ability of derivatives markets to transfer risks.

### REFERENCES INCLUDE

Patent Pending U.S. Ser. No. 11/269,645 “Derivative Securities utilizing commercial real estate indices as underlying”, Name of Applicant: Patrick P. Lecomte, Filing Date: Nov. 9, 2005
Black D. [1986] “Success and Failure of Futures Contracts: Theory and Empirical Evidence” Monograph 19861, Monograph Series in Finance and Economics, Graduate School of Business Administration, New York University.
Duffie D. and R. Rahi [1995] “Financial Market Innovation and Security Design: An Introduction”, Journal of Economic Theory, 65.
Ederington L. [1979] “The Hedging Performance of New Futures Markets” The Journal of Finance, 34 (1)
Fishburn P. [1977] “Mean-Risk Analysis with Risk Associated with Below-Target Returns” The American Economic Review, 67 (1).
Fisher J. [2005] “New Strategies for Commercial Real Estate Investment and Risk Management” Journal of Portfolio Management—Special Real Estate Issue, September 2005.
FitzGerald G. [2005] “Anticipating Change in Drug Development: The Emerging Era of Translational Medicine and Therapeutics”, Nature Reviews, Volume 4, October 2005.
Hartzell D., J. Heckman and M. Miles [1986] “Diversification Categories In Investment Real Estate”, AREUEA Journal, Vol. 14, N. 2.
Howard C., and D'Antonio L. “A Risk-Return Measure of Hedging Effectiveness” Journal of Financial and Quantitative Analysis, 19 (1).
Labuszewski J. [2006] “Introduction to the CME CSI Housing Futures and Options”, CME Research & Product Development, Chicago Mercantile Exchange.
Lecomte P. and W. McIntosh [2005a] “Is This a Revolution?” The Institutional Real Estate Letter Vol. 17 N. 10 (October)
Lecomte P. and W. McIntosh [2005b] “Going Synthetic” The Institutional Real Estate Letter Vol. 17 N. 11 (November)
Lecomte P. and W. McIntosh [2006] “Designing Property Futures and Options based on NCREIF Property Indices” Paper presented at the 22^{nd} American Real Estate Society Annual Meeting in Key West, Fla. (April 2006)—Best Manuscript winner in the Real Estate Finance category sponsored by the Fannie Mae Foundation. Journal of Real Estate Portfolio Management, forthcoming, 12:2.
Miles M. and T. McCue [1982] “Historic Returns and Institutional Real Estate Portfolios” AREUEA Journal, 10:2
Massachusetts Institute of Technology [2005] “MIT engineers an anti-cancer smart bomb”, Jul. 27, 2005 (News Office Correspondent).
Mueller G. and B. Ziering [1992] “Real Estate Portfolio Diversification Using Economic Diversification”, The Journal of Real Estate Research, Vol. 7 N. 4 (Fall).
Rang H., M. Dale, J. Ritter and P. Moore [2003] “Pharmacology”, Churchill Livingstone, 5^{th} edition.
Riddiough T. [1995] “Replicating and Hedging Real Estate Risk” Real Estate Finance (Fall); 12, 3.
Sharpe W. [1995] “Nuclear Financial Economics” in Risk Management: Problems and Solutions (W. Beaver and G. Parker, editors) MacGraw-Hill
Shiller R. [1993] “Macro Markets: Creating Instruments for Managing Society's Largest Economic Risks” Clarendon Lectures in Economics, Clarendon Press. Oxford University Press.
Sledge G. [2005] “What is Targeted Therapy?”, Journal of Clinical Oncology, Vol. 23, N 8 (March 10)
Weatherall M. [1997] “Drug Therapies” in Companion Encyclopedia of the History of Medicine (Bynum and Porter, Editors), Routledge, paperback, Vol 2, 39.

### BRIEF SUMMARY OF THE INVENTION

This specification presents the design of two novel derivative instruments called Combinative Derivatives and Factor Hedges. It also presents the general principles of a market template for trading Factor Hedges. This type of market is known as Market for Hedging Effectiveness. The instruments described in this document are meant to be traded over the counter or listed on organized exchanges. Financial markets, derivatives exchanges and investment banks might be interested in these instruments and market template as new business developments. Potential users of these instruments are numerous and include participants in the real estate industry, fund managers, pension funds and more generally any parties interested in investment management and risk management.

The instruments and market template described in this specification accommodate complex risk structures derived from multi factor models. They enable investors to hedge risks involved in heterogeneous real assets such as commercial real estate assets in an efficient, cost effective though tailor-made manner at both the aggregate and the individual asset levels. They might also be used by non-hedging investors as a way to diversify property portfolios and financial asset portfolios alike.

### BRIEF DESCRIPTION OF THE SEVERAL VIEWS OF THE DRAWING

Page 23 of the application contains four drawings numbered from Figure A to Figure D. Each figure depicts the implied risk structure and corresponding mode of approach of a model of property derivatives. Figures A and B cover existing models of derivatives. Figures C and D cover the two models of derivatives described in this specification. In each drawing, the arrow(s) indicate(s) the mode of approach used by the hedge instrument (left hand side) represented by one or several circle(s)/ellipse(s) in order to deal with the risk symbolized by the bar (right hand side). The four drawings describe the same risk but as shown by the stacked bar on the right hand-side of each drawing, the underlying risk's implied structure depends on the assumptions made by the model of derivative instruments used for hedging.

Figure A is entitled Composite Index-Based Derivatives. This unifactorial model is the basic dual approach to risk applied by financial derivatives: risk has a systematic component and an idiosyncratic component. This derivative template is modelled after one-factor models such as the Capital Asset Pricing Model. Because of minimal causal analysis, cross hedge basis risk is potentially very important.

Figure B is entitled Narrow Based Index or Hedonic Index Derivatives (see Lecomte and McIntosh [2006], Shiller [1993]). The risk structure is acknowledged as multifactorial but interactions between factors are poorly understood. Index design aims to mimic underlying cash market's characteristics. To do so, this derivative template uses aggregate underlying and an index-based template, which generates basis risk. Basis is lower than in the case of composite indexes.

Figure C is entitled Combinative Derivatives. It depicts the implied risk structure and mode of approach of Combinative Derivatives. Combinative Derivatives are the first type of instruments covered. In its simplest form, a combinative derivative could be made up of a futures contract tied to a property type sub-index and add-on features linked to selected economic indicators. This model follows what this specification calls the ‘smart bomb template’. Components of these aggregate hedges are individually tradable. It is a multifaceted approach to real estate risk that combines standardization and customization.

Figure D is entitled Factor-Based Hedging Instruments. It depicts the implied risk structure and mode of approach of Factor Hedges. Factor Hedges are the second type of instruments described. They embody the ultimate step in the process of customization. Factor Hedges materialize into sophisticated instruments where all underlying are factors. One factor may impact several risk components, which can make these instruments difficult to implement in practice without the design of a new type of derivatives market known as Market for Hedging Effectiveness as described.

### DETAILED DESCRIPTION OF THE INVENTION

This section of the specification presents the methodology applied in the process of making the invention, the description of Combinative Derivatives, the description of Factor Hedges, and the general structure and mechanics of a new market known as Market for Hedging Effectiveness where these instruments will trade.

Methodology applied in the process of making the invention: We use a biomedical analogy to describe real estate risk and define the best ways to hedge it. The premise of our methodology is to recognize that biomedical sciences and real estate risk management share common conceptual issues insofar as they both have to deal with complex phenomena. The concept of disease provides a useful framework for analyzing a complex phenomenon involving patterns immersed into the confusion of a total environment. Our method is in sharp contrast with the prevalent use of mathematics and physics in finance.

We apply the analogical framework presented in Appendix 1. Recent advances in drug therapies (see Sledge [2005], FitzGerald [2005]) provide hints as to possible underlying and structures of hedge instruments for heterogeneous real assets such as real estate:
Drugs are composite (aimed at broadly defined generic diseases), specific (aimed at narrowly defined diseases) or pure (as therapeutic agents aimed at one molecular target involved in the disease process).
Mode of delivery involves monotherapy (one drug), combination therapy (several drugs) either indiscriminately, targeted (e.g. smart bomb) or individualised (e.g. individualised medicines).
Optimal treatment efficacy is achieved by combining purified drugs with selective modes of delivery.

Hence, translating these concepts in terms of hedge instruments, we find that:
Underlying is composite (e.g. NCREIF Property Indices), specific (e.g. hedonic or narrow based indices) or ‘pure factor’ covering one particular dimension of total risk. ‘Pure factor’ refers to a factor free of outside influence. It is the equivalent of a ‘pure’ drug or an engineered therapeutic agent in biomedical sciences (see Weatherall [1997], FitzGerald [2006]). In statistical terms, it means that the factor is freed of multicollinearity, as much as it is possible to do so by using statistical and econometric methods. Appendix 2—Table 1 summarizes our analysis.
Product structure involves one underlying (e.g. any single index based derivatives), several underlyings either indiscriminately, targeted (i.e. combinative Instrument) or individualised depending on the asset's internal and external components (i.e. factor based instrument). Appendix 2—Table 2 summarizes our analysis.
Efficient instruments combine specific underlying with innovative product structures. Appendix 2—Table 3 summarizes our analysis.

The biomedical analogy enables us to identify two models of derivatives that are more efficient than current products for hedging risk in real estate assets: combinative derivatives and factor hedges. These two models known as Combinative Instrument and Factor Based Instrument are mentioned in the analogical framework presented in Appendix 1—Section 3C of this document.

Principles behind Combinative Derivatives: Complex phenomena are better addressed from various angles (either simultaneously or sequentially) rather than frontally. A combinative approach allows for greater efficiency and/or flexibility. It can serve to contain the phenomenon. This template refers to cells 1B, 2B and 3B in Appendix 2—Table 3 of this document. It emulates the concept of combination therapy in medicine and is mentioned in the analogical framework under the wording ‘Combinative Instrument’ presented in Appendix 1—Section 3C of this document.

Choice of underlying for Combinative Derivatives: Index or factor interactions expressed by multicollinearity could represent a major shortcoming of combinative derivatives. To mitigate that risk, combinative derivatives are based on an assortment of composite indices, specific indices and factors. A combinative hedge instrument akin to a smart bomb in biomedical sciences mixes several individual hedges selected by their users to best cover corresponding constituents of a given risk. This new derivative defines the ‘smart bomb template’ presented in this specification. The smart bomb template will take the shape of a futures contract based on a broadly defined sub-index with add-on factor based features (e.g. options), resulting in a customizable hybrid hedging vehicles made up of standardized (and hence tradable) derivatives products (see Drawings—Figure C).

The smart bomb template conveys a hierarchy of causes as opposed to existing models of derivatives (see Drawings—Figures A and B). In effect, there is a main ‘efficient’ cause (i.e. captured with the futures) and additional causes (encapsulated in the choice of underlying factors). There is extensive academic literature to support this analysis. Specifically, research on diversification benefits of real estate portfolios explains that property type is the most important dimension in determining different commercial real estate market behaviours (see Miles and McCue [1982]). Economic diversification literature also shows that incorporating location into a combinative instrument is optimally achieved by considering economic variables rather than purely geographic criteria. Economic base categories (EBC) stress the importance of local economics and provide a first approach to selecting relevant economic indicators (see Mueller and Ziering [1992]).

In its simplest form, a combinative derivative's main component (e.g. futures) is based on some specifically defined property type sub-index while add-on features (e.g. options) are tied to economic variables representative of the location component of a commercial real estate asset. This template is not strictly causal since the brunt of the risk is still expressed in terms of an asset's generic physical dimension. Nonetheless, it epitomizes a major step in that direction. Its originality stems form its ability to combine standardization and customization within a single aggregate instrument that encompasses real estate risk's polymorphous dimension. It is a multifaceted approach whose main objective is to contain the phenomenon.

In terms of product design, the smart bomb template described (i.e. futures plus add-on option-like features) has many advantages. First, the possibility to separate between two dimensions (i.e. property type and location) eases its practical implementation. Likewise, the fact that its main component is based on a generic property type (or a crossover property type×region or a crossover property type×Metropolitan Suburban Area known as MSA) will mitigate market authorities' reservations with respect to narrow based indices. The use of economic indicators instead of geographic factors significantly reduces the risk of real estate cash market manipulation.

Practical implementation of Combinative Derivatives: The smart bomb template does not require the establishment of a new type of derivatives market. Providing further advances in the nascent field of economic derivatives, it will rely on existing derivatives markets. Combinative derivatives may also trade on the market template described.

To allow for the standardization necessary to create a liquid market, all features in a combinative hedge are bundled together at purchase but under some restrictive conditions, market participants can trade them separately.

The selection of hedge components is done using an interactive computer assisted platform with specific scroll menus and choices based on type of hedge and property type selected by users. The platform is fed with historical and real time data. Appendix 3 presents a pro format input form for combinative property derivatives.

Concepts underpinning Factor Hedges: Factor hedges emulate in the field of risk management and derivatives the concept of individualized medicines described in FitzGerald [2005].

Factor hedges are fully individualized hedging products traded on a new kind of standardized market called Market for Hedging Effectiveness as presented. These instruments are no longer derivatives per se inasmuch as their value does not derive from that of the underlying asset but from risk variables or ‘pure’ risk factors impacting the cash market. Factor hedges are sophisticated combinative instruments where all underlying are ‘pure’ risk factors as illustrated in Drawings—Figure D. This template refers to cell 3C in Appendix 2—Table 3 of the specification. It is mentioned in the analogical framework under the wording ‘Factor Hedge’ presented in Appendix 1—Section 3C of the specification.

Factor hedges embody a move from the commodity or price hedging approach usually applied in risk management to a template focused on risk hedging (rather than price hedging). Their premise is to acknowledge that effective hedging of risks involved in commercial real estate investment, and in any heterogeneous real asset, requires the separation of the asset defined as a bundle of characteristics from individual factors impacting these characteristics. A major hurdle to effective hedging of real assets' risks lies in an inherently flawed conception of the hedging process. In models presented in Drawings—Figures A and B, hedging is essentially about replicating the phenomenon as faithfully as possible after Ederington [1979]. Riddiough [1995] presents such an approach for commercial real estate. With Factor Hedges, the analysis is radically different. It hinges on thoroughly understanding variables or ‘pure’ factors whose interactions with the internal component of a real asset (i.e. a building) and external components of a real asset (i.e. a building's environment at large) generate risk.

Pure factors: Pure factors are defined. Pure factors are used as underlying of Factor Hedges. They are of a dual nature: internal for interactions caused by an asset's characteristics with its outside environment (micro factors) and external for interactions stemming from outside variables with the asset (macro factors). Micro factors are asset class specific. For Factor Hedges used for hedging risk in commercial real estate, they only apply to real estate assets. They include any variable linked to an asset's idiosyncratic characteristics, e.g. those that define an asset's physical properties. Macro factors include, but are not restricted to, economic indicators and financial market indicators. They are common to many asset classes. Therefore, macro factors are interchangeable and easily traded among different asset classes.

Market for Hedging Effectiveness: A new market template is required for trading Factor Hedges because of the issue of multicollinearity that may arise in the context of multiple factors being aggregated in a single hedge. Multicollinearity is a frequent shortcoming of factor models used in finance (e.g. Asset Pricing Theory or APT).

The market template to be used with Factor Hedges modifies the way the concept of hedging effectiveness is customarily applied in risk management and derivatives markets. In the classical framework, hedging effectiveness results from an optimal combination of underlying and product structure given the cash market's characteristics. The derivative instrument is designed in a way that provides maximum correlation with the risk to be hedged (see. Black [1986], Duffie and Rahi [1995]). The market presented in this specification inverses the proposition and considers hedging effectiveness not as a consequence of the hedge but as a condition defined by users when initiating the hedge. This concept is called Market for Hedging Effectiveness or Market for Basis. It embodies the notion that in incomplete markets, hedging is by definition imperfect.

General principles of the Market: The Market for Hedging Effectiveness will make massive use of modern information technologies. Databases containing historical and real time information about pure factors are fed into a platform (called system in the specification). The system constantly matches assets to be hedged (either single properties or portfolios of properties) with possible combinations of factors to achieve maximum hedging effectiveness. Through an iterative process using descriptive as well as historical information about the asset(s), the system maps the risk profile of the asset(s) and determines a ‘risk scan’ as shown in appendix 4. This is done at inception of the hedge and on a continuous basis throughout the life of the hedge in order to capture subtle variations in the asset's risk profile. From the risk scan, the system comes up with an initial optimal hedge that best matches the asset(s)' risk profile given a set of criteria selected by users including, but not restricted to, the desired level of hedging effectiveness (defined by an indicator such as the R-square variable used in the mean-variance model of Ederington [1979]) and the time horizon of the hedge. If users' expectations are not achievable, the system indicates the best possible attainable combination that maximizes hedging effectiveness and the level of confidence given the time constraint. This process determines the optimal initial combination of factors. The system may ask users to choose among several possible combinations or choices. The combination selected by the users is rebalanced periodically (e.g. daily) to achieve optimal levels of hedging effectiveness. Periodical rebalancing entails a process called ‘marked to basis’ in which depending on the level of hedging effectiveness achieved between two consecutive periodical combinations of factors, users may be required to deposit additional fund into a ‘basis’ account. These deposits are known as ‘basis calls’. Factor Hedges are cash-settled.

Dynamic hedging strategies assisted by genetic algorithms: The optimization as well as the rebalancing process leading to successive optimal combinations of factors is done using genetic algorithms. Thus, a factor hedge adapts itself to the changing structure of real estate risk and variations in underlying factors. As a result, users do not have to worry about hedge ratios. The system automatically generates dynamic hedging strategies. A market for hedging effectiveness is a market without hedge ratios. It circumvents the issue of multicollinearity: what matters is the aggregate effect of the hedge and its match with the cash asset(s).

For a given asset, the higher the expected hedging effectiveness, the higher the price of the hedge. The price of the hedge also depends on the risk factor combination (each factor having a different price) and the time horizon selected by users.

A market for hedging effectiveness using ‘pure’ factors as described represents the ultimate stage in the customization process of commercial real estate hedge instruments. Tailor-made factor hedges will create a market with no cross hedge basis risk, no mismatch of maturity, and no risk of manipulation in underlying real estate markets. The market will allow inter asset class counterparty of ‘pure’ factors.

In parallel to the Market for Hedging Effectiveness, there is a secondary market known as ‘Factor Market’ aimed at hedgers and non-hedgers alike. The Factor Market is used for trading a wide range of single ‘pure’ factors, thereby allowing exchanges of factors among single and multiple asset classes (even completely different asset classes). Factor standardization is crucial in establishing a fully fledged factor market.

### Appendix 1

The following analogical framework is applied to derive the two models of derivatives described in the specification:

### Section 1: Explanation Target

How can we best hedge real estate risk?

### Section 2: Explanation Pattern

1—Real estate risk is like a multi-factorial disease.
2—Multifactorial diseases are best treated by using targeted therapies with highly specific therapeutic agents, or individualised medicines.
3—Real estate risk may be best treated by using targeted or individualised hedges with specific underlying.

### Section 3: Details

The symbol → is used below to signify the analogy between two concepts. It stands for: “this concept in real estate finance/risk management is analogous to the following concept in biomedical sciences”.

### A—Real Estate Risk

### Real Estate Risk→Multifactorial Disease

Risk affects properties' income producing ability→Disease affects the normal functioning of human bodies
Each building is different→Each patient is different
Buildings are subject to obsolescence→Patients suffer from aging

### B—Hedging

Hedge→Treatment (drug therapy)

### Underlying→Drug

Composite index→Generic, mass market drug

Narrow based index→Specific, niche market drug

Pure factor→Engineered therapeutic agent, pure drug

### Product Structure→Mode of Delivery

Underlying×Product Structure→Drug×Mode of delivery

### Hedging Effectiveness→Therapeutic Efficacy

### Basis→Side Effects

### Hedge Ratio→Dosage

### C—Product Design

### Index-Based Derivative→Monotherapy

Combinative Instrument→Combination Therapy (smart bomb, targeted therapies)

### Factor Hedge→Individualised Medicine.

### Appendix 2

TABLE 1
Possible underlying of real estate hedge instruments

| Proposed Underlying | Analogy (Drug) |
|---|---|
| 1 - Composite Index | Generic, mass-produced drug. |
| | Blockbuster, “one size-fits-all” model |
| | with potentially important troublesome |
| | side-effects. |
| 2 - Specific Index (e.g. hedonic) | Disease specific, niche market drug. |
| 3 - Pure Factor | Pure drug/Engineered therapeutic agent |
| | individually selected and combined. |

TABLE 2
Possible structures of real estate hedge instruments

| Proposed Structure | Analogy (Mode of delivery) |
|---|---|
| A - Index-Based Derivative | Monotherapy. |
| B - Combinative Instrument | Combination therapies: targeted |
| | therapeutics, smart bombs. |
| C - Factor-Based | Individualised medicine aiming for |
| Instrument | optimal efficacy and minimum side effects. |

Crossing the three possible underlying (numbered from 1 to 3) with the three possible mode of delivery (referenced from A to C), we define 9 possible models for property derivatives (from 1A to 3C - See table 3 below).

TABLE 3
Generic models of derivatives

| | | Combinative | Factor Based |
|---|---|---|---|
| Structure/Underlying | Index Based Derivative | Instrument | Instrument |
| Composite Index | Current property | Model reviewed in | [symbol] |
| | derivatives (e.g. NPI- | paragraphs [018] to | |
| | based swaps) | [025] of the specification | |
| | [symbol] | [symbol] | |
| Specific Index | Narrow based index | Model reviewed in | [symbol] |
| | (e.g. Lecomte and | paragraphs [018] to | |
| | McIntosh [2006]) or | [025] of the specification | |
| | hedonic index based | [symbol] | |
| | derivatives (e.g. Shiller | | |
| | [1993]) | | |
| | [symbol] | | |
| Pure Factor | [symbol] | Model reviewed in | Model reviewed in |
| | | paragraphs [018] to | paragraphs [026] to |
| | | [025] of the specification | [029] of the specification |
| | | [symbol] | [symbol] |

Letter Numbers in bold italics ( [symbol] , [symbol] . . . ) refer to underlying/structures presented above in tables 1 and 2. Current property derivatives are composite index based instruments ( [symbol] ) which emulate a “one-size-fits-all”monotherapy. Shiller [1993] is mentioning hedonic index-based derivatives ( [symbol] ). Lecomte and McIntosh [2006] are describing narrow based index derivatives ( [symbol] ). Three generic models are conceptuallyunfeasible (highlighted grey cells in table 3 above: [symbol] , [symbol] , [symbol] ) because of underlying and product structure. To be relevant, innovations in mode of delivery have to be accompanied with simultaneous advances in the purity of underlying. Thus, the biomedical analogy has enabled us to identify two new models of derivative: combinative structures ( [symbol] , [symbol] , [symbol] ) and the factor model ( [symbol] ).

What is claimed is:

1- Our method based on an analogical framework which applies concepts, methodologies, references used in biomedical sciences (biology, pharmacology, medicine, genetics and any related fields) to issues in finance provides a powerful tool for analyzing complex phenomena affecting prices of real assets such as commercial real estate assets.

2- The method of claim 1 gives rise to a new field of real estate finance called ‘biorealfinance’, i.e. the use of concepts, tools, methodologies, references stemming from biomedical sciences in order to explain and deal with complex phenomena in real estate finance.

3- Combinative derivatives and factor hedges are two innovative templates of hedge instruments which accommodate multifactorial asset pricing models.

4- Instruments of claim 3 enable optimal hedging effectiveness of derivatives tied to heterogeneous real assets such as commercial real estate assets.

5- Factor hedges of claim 3 are based on an innovative concept of risk factors called ‘pure factors’ which are of a dual nature (i.e. micro-factors which are asset-class specific and macro-factors which include, but are not restricted to, economic indicators and financial market indicators), thereby capturing the internal and external dimensions of the risk of a real asset.

6- The Market for Hedging Effectiveness is a new template of derivatives market which solves the issues of muticollinearity embedded in multifactor pricing models by developing innovative concepts such as ‘risk scan’, ‘basis call’ and hedges being ‘marked to basis’ and rebalanced periodically using genetic algorithms.

7- The Market for Hedging Effectiveness of claim 6 allows optimal hedging effectiveness of derivatives tied to multifactor pricing models.

8- The Market for Hedging Effectiveness of claim 6 allows the trading of risks among different asset classes.
